(19) United States
(12) Patent Application Publication
(10) Pub. No.: US 2007/0186063 A1
(43) Pub. Date: Aug. 9, 2007

(54) Portable electronic device

(75) Inventors: Akiyoshi Mogi, Kawasaki-shi (JP); Yoshinori Yuki, Fuchu-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/493,257

(22) Filed: Jul. 26, 2006

(30) Foreign Application Priority Data
Feb. 8, 2006 (JP) 2006-031503

(51) Int. Cl. G06F 13/00

(52) U.S. Cl. 711/158

(57) ABSTRACT

Content data is classified into a data block group of high priority and an other data block group of low priority related to a user's operation. When the content data is read from a storage unit to store it in a buffer memory, a preferential data block group is firstly and selectively read to store it in the buffer memory, and then, a non-preferential data block group is read to store it in the buffer memory. In a state where free areas are present in the buffer memory, the read data blocks are stored in the free areas. When the buffer memory runs out of all free areas therein, the read data blocks are overwritten on non-preferential data blocks.

### CROSS-REFERENCE TO RELATED APPLICATIONS

This application is based upon and claims the benefit of priority from prior Japanese Patent Application No. 2006-031503, filed Feb. 8, 2006, the entire contents of which are incorporated herein by reference.

### BACKGROUND OF THE INVENTION

1. Field of the Invention

The present invention relates to a portable electronic device, for instance, a portable communication terminal such as a cellular phone and a personal digital assistant (PDA), and a portable electronic device such as a portable game machine, an audio/video player and a digital camera. In particular, the present invention relates to a portable electronic device reproducing content data stored in a storage unit through a buffer memory.

2. Description of the Related Art

In general, a personal computer and an optical disk reproducing device have built-in buffer memories. For reproducing data stored in the storage unit, the personal computer and optical disk reproducing device each read the data in block units from the storage unit to store it in the buffer memory temporarily then reproduce it. By such a configuration, the data can be reproduced continuously and smoothly. The configuration is disclosed, for instance, in Jpn. Pat. Appln. KOKAI Publication No. 10-188446.

On the other hand, a large number of portable communication terminals such as cellular phones have been configured to have functions of storing content data, for instance, downloaded from a website in a hard disk storage device or a storage unit such as a memory card with a non-volatile property and of reading the content data from the storage unit to reproduce it. Even in such a type of a terminal, the reproduction of the content data is performed through the buffer memory.

The portable communication terminal however has a built-in buffer memory with an extremely small capacity in comparison to that of the personal computer or optical disk reproducing device. Thereby, the portable communication terminal can not always store all data of content read from the storage unit to its buffer memory. In the case of overflow of the buffer memory therefore the communication terminal sequentially overwrites and stores the newly read data on the data first read.

Accordingly, for instance, if a user operates to reproduce over again the content from the first part of the content, or if the user operates to reproduce attachment data such as song lyric data and image data arranged at the first part of the content, the communication terminal reads again the corresponding data from the storage unit to store it in the buffer memory then reproduces it. Therefore, it takes a relatively long time to start the reproduction of the data after the user operates to reproduce it, and a reproduction response property is extremely bad.

### BRIEF SUMMARY OF THE INVENTION

The present invention provides a portable electronic device capable of starting reproduction processing in response to a user's request quickly in a short waiting time when a user's operation is performed during reproduction of content data to improve a reproduction response property.

One view point of the invention is to provide a portable electronic device reading content data from a storage unit to temporarily store it in a buffer memory, and then, reproducing it by a reproduction unit, wherein the electronic device divides the content data into a first data block group with a first priority given thereto in relation to a user's operation and a second data block group with a second priority lower than the first priority given thereto. The electronic device then reads the content data in block units to temporarily store the read data blocks in the buffer memory in accordance with their priorities. And then, the electronic device selectively reads the content data from the buffer memory to reproduce it through the reproduction unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing a configuration of a cellular phone that is an embodiment of a portable electronic device regarding the present invention;

FIG. 2 is an exemplary block diagram showing a functional configuration of a control unit of the cellular phone shown in FIG. 1;

FIG. 3 is an exemplary flowchart showing a procedure and content of content data reproduction control by the control unit shown in FIG. 2;

FIG. 4 is an exemplary flowchart showing a procedure and content of buffering processing in the content data reproduction control shown in FIG. 3;

FIG. 5 is an exemplary flowchart showing a procedure and content of data reproduction processing in the content data reproduction control shown in FIG. 3;

FIG. 6 is an exemplary view showing an example of a configuration of data to be buffer-managed;

FIG. 7 is an exemplary view showing a first example of a storage state of data blocks in a buffer memory; and

FIG. 8 is an exemplary view showing a second example of the storage state of the data blocks in the buffer memory.

### DETAILED DESCRIPTION OF THE INVENTION

At first, a brief description of a portable electronic device regarding an embodiment of the present invention will be provided.

In the embodiment of the invention, the portable electronic device reading out content data from a storage unit to temporarily store it in a buffer memory and then reproducing it by a reproduction unit divides the content data into a first data block group with a first priority given thereto in relation to a user's operation and a second data block group with a second priority which is set lower than the first priority given thereto. The electronic device is configured in that it reads the content data in block units to store the read data blocks in the buffer memory in accordance with their priorities and selectively reads the data blocks stored in the buffer memory to reproduce the content data through the reproduction unit.

Thus, the data blocks read from the storage unit are stored in the buffer memory in accordance with their priorities. The buffer memory thereby preferentially stores and holds the first data block group with a high priority. Accordingly, even when the user's operation is performed during reproducing the content data, the electronic device preferentially reads the first data block with a high priority related to the user's operation to provide it to reproduction processing, and then, the electronic device can enhance its reproduction response property.

The embodiment of the invention is also characterized by being provided with the following specific configuration.

A first configuration stores the data blocks read from the storage unit in free areas of a buffer memory in a state in which the free areas are present in the buffer memory. In contrast, in a state in which no free area is present in the buffer memory, the electronic device stores the data block read from the storage unit as a substitute for a second data block among a first and a second data block stored in the buffer memory.

By this configuration, even in the case of overflow of the buffer memory, the electronic device eliminates the risk that the first data block with the high priority is overwritten by the second data block with the priority lower than the first priority. Thus, the electronic device can keep to store the first data block with the high priority in the buffer memory.

A second configuration reads the first data block group in block units from the storage unit to store it in the buffer memory, and reads the second data block group in block units to store it in the buffer memory after completing the read of the first data block group.

By this configuration, the first data block with a high priority is firstly read to be stored in the buffer memory. Thereby, even if the first data block is arranged in any position in the content data, the first data block can be firstly stored in the buffer memory. In other words, the electronic device can preferentially store all items of information necessary for reproduction control of the content data in the buffer memory, thereby; it can start reproduction control of the content data instantaneously.

A third configuration is provided with a memory table to store information indicating an arrangement position of the first data block in the content data. In the event of an input of a reproduction request for the content data, the electronic device determines a type of the content data to be reproduced, reads the information indicating the arrangement position of the first data block corresponding to the determined type from the memory table, then, selectively reads the first data block group from the storage unit to store it in the buffer memory on the basis of the read information showing the arrangement position.

As such configuration, the electronic device can perform buffering processing in response to the priority only for the content data of the type needed to be buffering-managed. And also it becomes possible for the electronic device to perform the buffering processing for each type of content data in accordance with an optimum priority appropriate for a data structure.

Next to this, a portable electronic device regarding an embodiment of the present invention will be set forth with reference to the drawings.

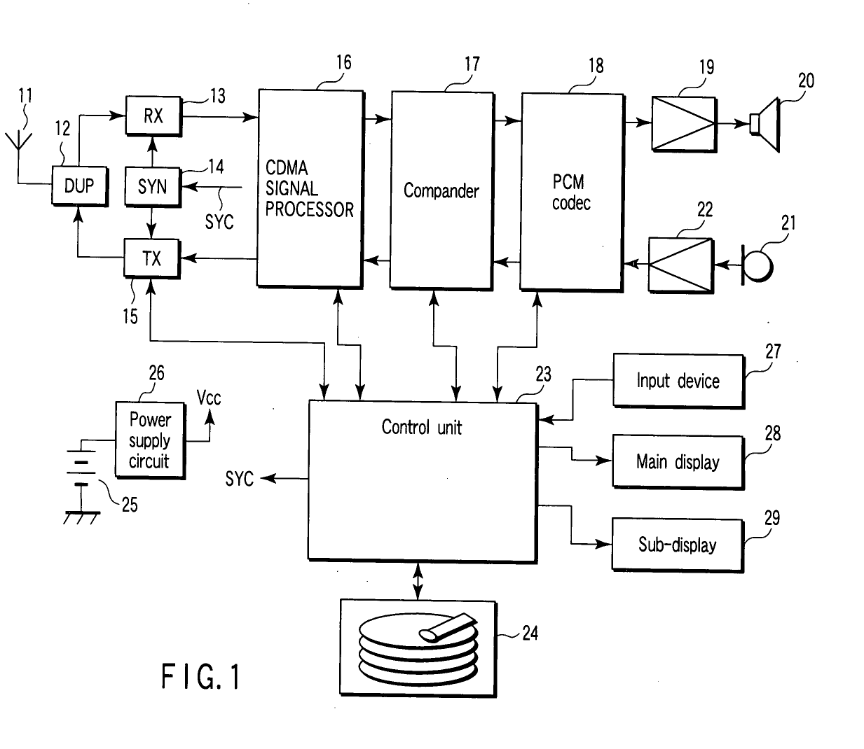

FIG. 1 is the block diagram showing the configuration of the cellular phone that is the embodiment of the portable electronic device regarding the invention.

A radio signal transmitted from a base station (not shown) is received by an antenna 11 then input to a receiving circuit (RX) 13 through an antenna duplexer (DUP) 12. The RX 13 mixes the received radio signal with a local oscillation signal output from a frequency synthesizer (SYN) 14 to frequency-convert (down-convert) it into an intermediate signal. And the RX 13 applies quadrature demodulation to the down-converted intermediate signal to output a received baseband signal. The frequency of the local oscillation signal generated from the SYN 14 is instructed by a control signal SYC output from a control unit 23.

The received baseband signal is input to a code division multiple access (CDMA) signal processor 16. The CDMA signal processor 16 has a RAKE receiver. The RAKE receiver applies reverse diffusion processing to a plurality of paths included in the baseband signal by diffusion signals, respectively. Signals of each path, which are applied the reverse diffusion processing, are applied an arbitration in phase to be synthesized with one another. Thus, received packet data in a prescribed transmission format is obtained. The received packet data is input to a compressor/expander (hereinafter referred to as compander) 17.

The compander 17, in speech communication, decodes speech data included in the received packet data output from the CDMA signal processor 16 is decoded through a speech codec and outputs a digital speech signal obtained through the decoding to a pulse code modulation (PCM) codec 18. The PCM codec 18 applies PCM decoding to the digital speech signal to output an analog speech signal. The analog speech signal is amplified by a reception amplifier 19 then output from a loud speaker 20.

The compander 17, in receiving e-mail or in downloading content, transfers e-mail data or content data included in the received packet data to a control unit 23. The control unit 23 performs storage and reproduction processing of the e-mail data or content data as follows.

That is, the control unit 23 firstly stores the e-mail data or content data transferred from the compander 17 in a hard disk drive (HDD) unit 24. When an input device 27 inputs a display request for e-mail, the control unit 23 reads the corresponding e-mail data from the HDD unit 24 to display it on a main display 28.

When a reproduction request of the content is input by the input device 27, the corresponding content data is read from the HDD unit 24. Then, if the content data is audio content, the control unit 23 outputs the audio data to the compander 17. As a result, the audio data is decoded by the compander 17 and amplified by the amplifier 19 to be output from the loud speaker 20 after being converted into an analog signal by the PCM codec 18.

In contrast, if the content data is video content, the control unit 23 decodes it by a video codec therein to display it on the main display 28. Also in the case in which video data is imaged by a camera (not shown), the video data is displayed on the main display 28 under the control of the control unit 23.

On the other hand, in the speech communication, a speech signal of a speaker input to a microphone 21 is amplified to an appropriate level by a transmission amplifier 22 then applied PCM coding processing through the PCM codec 18 to be made as a digital audio signal, and input to the compander 17. The video signal output from the camera (not shown) is digitized through the control unit 23 and input to the compander 17. Text data such as e-mail created in the control unit 23 is also input to the compander 17 from the control unit 23.

The compander 17 detects an energy quantity of the input speech from the digital audio signal output from the PCM codec 18 to determine a transmission data rate on the basis of the detection result. The compander 17 then encodes the digital audio signal into a signal in a format corresponding to the transmission data rate to generate audio data in accordance with the encoding. The compander 17 generates video data by encoding the digital video signal output from the control unit 23. And the compander 17 packetizes the audio data and video data in accordance with a prescribed transmission format by the multiplexer/demultiplexer therein to output it to the CDMA signal processor 16. Even when text data such as e-mail is output from the control unit 23, the text data is multiplexed into the transmission packet data.

The CDMA signal processor 16 applies spectrum diffusion processing to transmission packet data output from the compander 17 by using a diffusion code assigned to a transmission channel assigned to a transmission channel. The CDMA signal processor 16 then outputs its output signal to a transmitting circuit (TX) 15. The TX 15 modulates the spectrum-diffused signal by using a digital modulation system, such as a quadrature phase keying (QPSK) system or a quadrature amplitude modulation (QAM) system. The TX synthesizes the transmission signal generated through the modulation with the local oscillation signal generated from the frequency synthesizer 14 to frequency-convert (up-convert) it into a radio signal. The TX 15 high-frequency-amplifies the radio signal so as to attain a transmission power level instructed from the control unit 23. The amplified radio signal is supplied to the antenna 11 and transmitted from the antenna 11 to the base station.

A sub-display 29 makes a display of information showing operation modes of the cellular phone, notification information of incoming calls and information showing a residual quantity or a charging state of a battery 25. A power supply circuit 26 generates a prescribed operation power supply voltage Vcc on the basis of the output from the battery 25 to supply it to each circuit unit. The battery 25 is charged by a charging circuit (not shown).

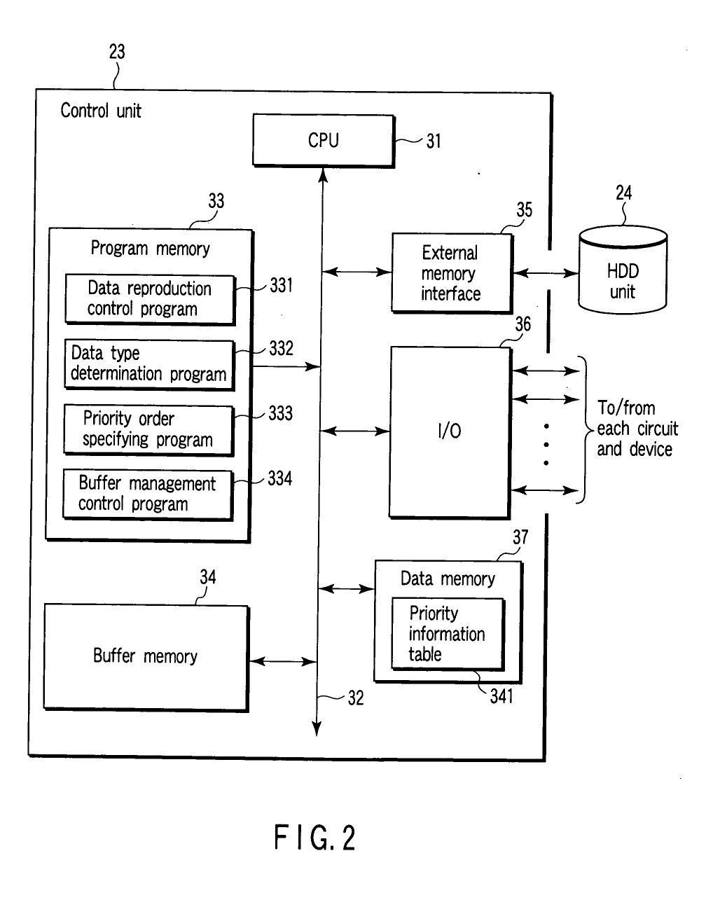

By the way, the control unit 23 is configured as follows. FIG. 2 is the block diagram showing the functional configuration. The control unit 23 has a central processing unit (CPU) 31. A program memory 33, a buffer memory 34 and a data memory 34 are connected to the CPU 31 through a bus 32, and further, an external memory interface 35 and an input/output port (I/O) 36 are connected thereto through the same.

A hard disk drive (HDD) unit 24 is connected to the external memory interface 35. The external memory interface 35 performs data write and read processing to and from the HDD unit 24 under the control by the CPU 31. The I/O 36 conducts input and output of the data to and form each circuit unit and device constituting the cellular phone.

The data memory 37 stores a priority information table 341 therein. The information table 341 stores information showing arrangement positions of data elements with high priorities out of content data, by associating the information to information indicating a type of the content data. As for a data element with a high priority, management data, etc., necessary for a data reproduction is selected.

The program memory 33 stores, as an application program required to implement the present invention, a data reproduction control program 331, a data type determination program 332, a priority order specifying program 333, and a buffer management control program 334.

When a user performs a reproduction operation for the content data through an input device 27, the data reproduction control program 331 reads the content data from the HDD unit 24, at every data block of a prescribed fixed length and stores it in a buffer memory 34. The control program 331 then makes the CPU 31 execute read processing of the content data from the buffer memory 34 to supply it to a unit responsible for reproduction processing. The unit responsible for the reproduction processing is, for instance, an audio decoder in the compander 17 if the content data is music content, and is a video decoder provided for the control unit 23 if it is video content.

For the reproduction processing of the content data, the determination program 332 makes the CPU 31 execute processing to determine whether or not the type of the content data read from the disk unit 24 is the music content or the video content. Other content to be determined include a various types of content, such as content with music content and video content mixed therein and content composed only of text data.

The priority order specifying program 333 selectively reads priority information, corresponding to the types of the content determined by the determination program 332, from the priority information table 341. And the specifying program 333 makes the CPU 31 execute processing to specify a data block corresponding to a data element with a high priority out of the read priority information.

When reading the content data from the HDD unit 24 to store it in the buffer memory 34, the buffer management control program 334 makes the CPU 31 execute processing for firstly and selectively reading data blocks each including data elements with the high priorities specified by the specifying program 333 to store them in the buffer memory 34. And the control program 334 makes the CPU 31 execute processing for reading other data blocks after reading the data blocks each including the data elements with the high priorities to store them in the buffer memory 34.

At the same time, the control program 334 makes the CPU 31 store the data blocks read from the HDD unit 24 in free areas in a state where any free area is present in the buffer memory 34. In contrast, in a state where any free area has not remained in the buffer memory 34, the control program 334 makes the CPU 31 execute processing for overwriting to store the data blocks read from the HDD 24 onto other data blocks except the data blocks with the high priorities among each data block stored in the buffer memory 34.

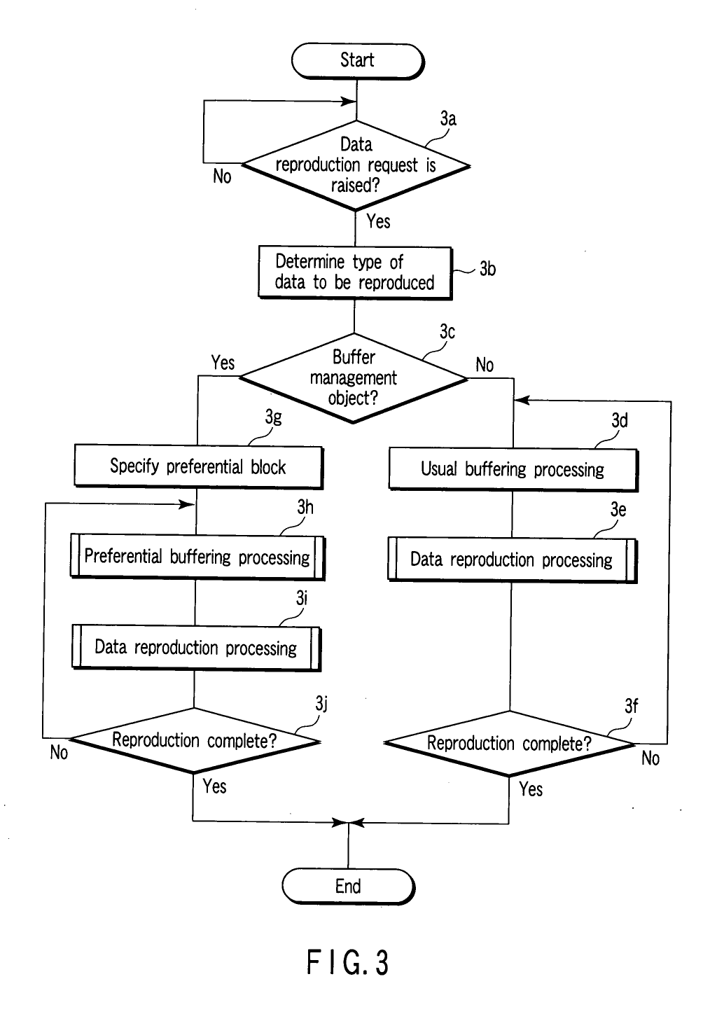

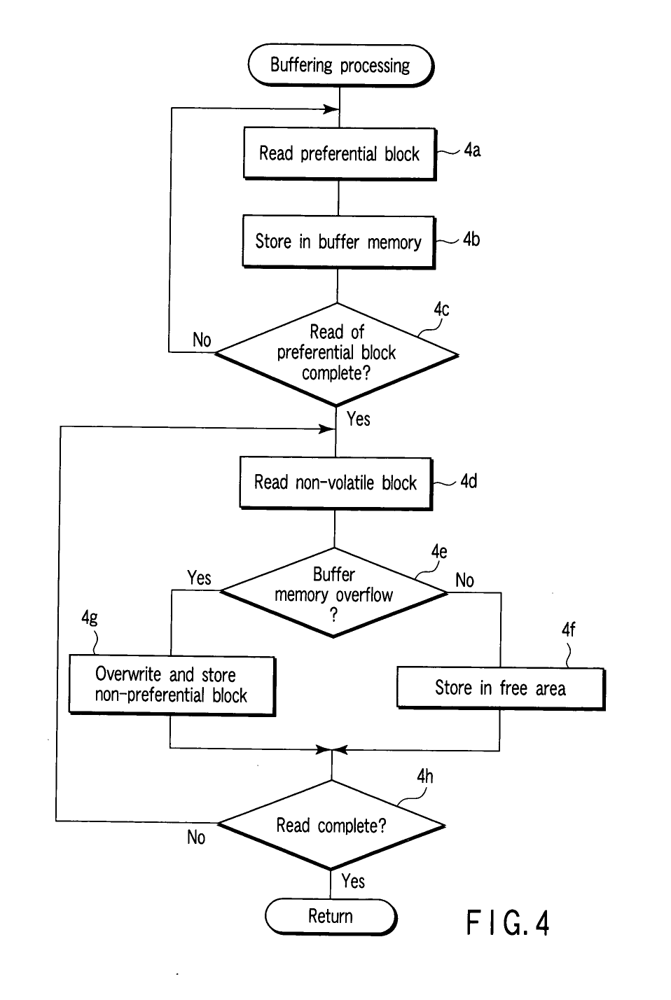

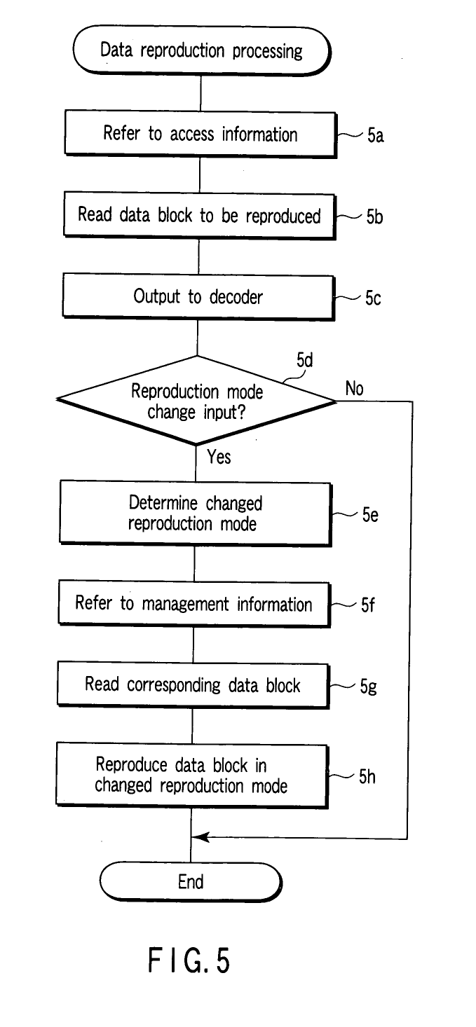

Next, a data reproduction processing operation by the cellular phone configured as mentioned above will be described. FIG. 3 is a flowchart showing a content reproduction control procedure and control contents by the CPU 31 in the control unit 23, FIG. 4 is a flowchart showing a procedure and contents of the preferential buffering processing in the flowchart shown in FIG. 3, and FIG. 5 is a flowchart showing a procedure and processing content of the data reproduction processing shown in FIG. 3.

In a waiting state, the CPU 31 monitors an input of a data reproduction request in a step 3a. In this state, it is presumed that the user conducts an operation for reproducing desired content data among the content data stored in the HDD unit 24 by the input device 27, the CPU 31 then firstly determines a type of data to be reproduced on the basis of forgoing operation information in a step 3b to determine whether or not the types of the data is required to be buffer-managed in a step 3c. This determination is conducted by confirming whether or not the corresponding data type has been registered in the priority information table 341.

The determination whether the data type needs the buffer management or not in the step 3c is not limited to determine whether the corresponding data type has been registered or not, and it may be performed by considering whether or not the whole of the data to be reproduced can be stored in the buffer memory 34. For instance, for reproducing music data of one piece of music, if the music data of the one piece of music has a volume possible to be stored in the buffer memory 34, the music data is not need to be buffer-managed. Both considerations whether or not the data type is one corresponding to the information table 341 and whether or not the data can be stored in the buffer memory 34 may be acceptable.

As the determination result, it is supposed that the type of the data to be reproduced has no need the buffer management. In this case, the CPU 31 shifts to a step 3d to execute usual buffering processing as follows. That is, the CPU 31 sequentially reads the data stored in the HDD unit 24 from the head position in block units to store data blocks in the buffer memory 34 in series. In the event of overflow of the buffer memory 34, the buffer memory 34 stores data blocks read out after the overflow as a substitute for the data block read out firstly. In other words, the buffer memory 34 overwrites and stores a new data block on an old data block.

After a part of or all of the content data is stored in the buffer memory 34, the CPU 31 sequentially reads out the data from the buffer memory 34 in a step 3e and supplies it to an audio decoder to perform a decode-reproduction. The buffering processing and the data reproduction processing of the data in the step 3d and the step 3e are repeatedly performed until a reproduction completion will be detected in a step 3f.

In contrast, as the determination result in the step 3c, it is supposed that the type of the data to be reproduced is one required to be buffer-managed. In this case, the CPU 31 firstly reads priority information corresponding to the data type from the priority information table 341 in a step 3g to specify a plurality of data blocks each including data elements of high priorities, namely a preferential data block group, from the priority information.

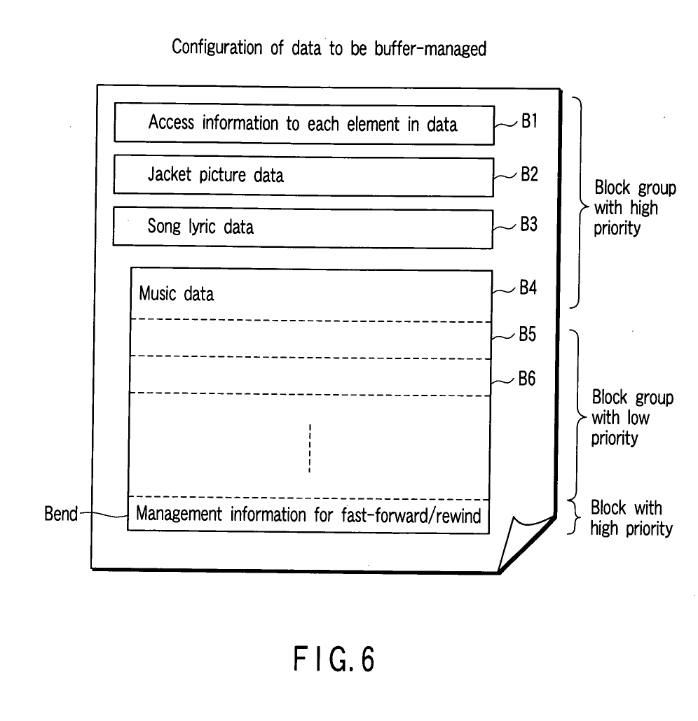

For instance, in the event of the music content, as shown in FIG. 6, the CPU 31 specifies access information B1 to each element in the content data arranged at the top position, jacket picture data B2, song lyric data B3, a data block B4 including a head position of the music data and a management information Bend arranged at a rear end for fast-forward/rewind, as data elements of high priorities.

The CPU 31 next executes preferential buffering processing as follows in a step 3h. At first, in a step 4a, the CPU 31 selectively reads the specified preferential data block group from the HDD unit 24 to sequentially store the read block group in the buffer memory 34 through a step 4b.

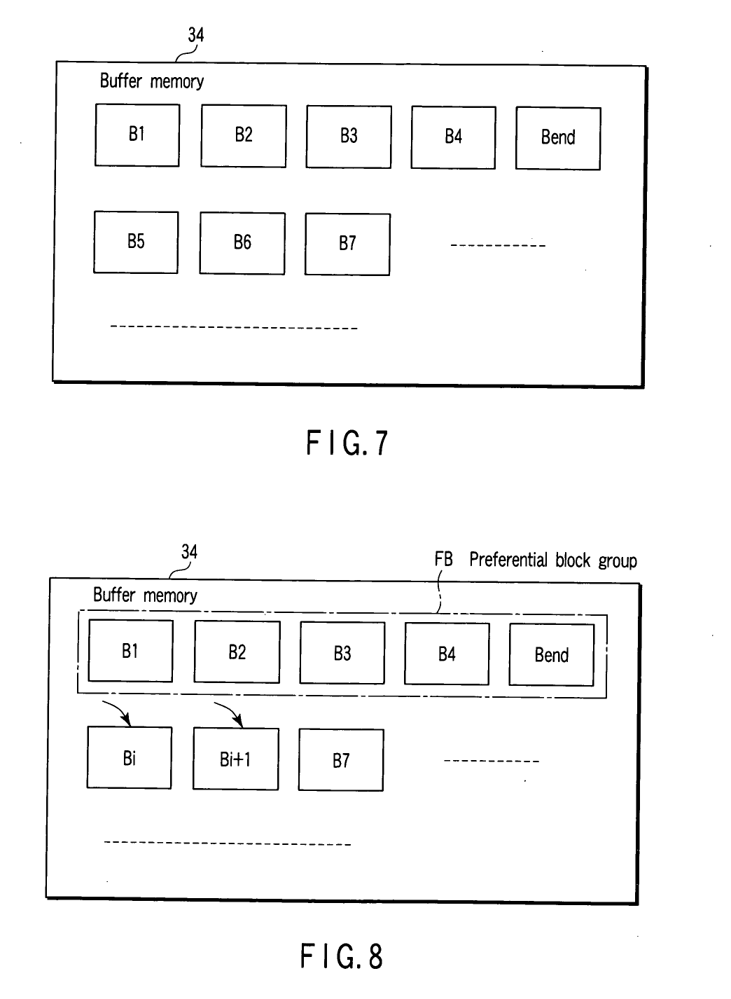

For instance, in the case of reading the music data expressed in FIG. 6, the CPU 31 selectively reads the access information B1 arranged at the top position of the data, jacket picture data B2, the song lyric data B3, the data block B4 including the top position of the music data, and the management information Bend arranged at the rear end of the music data to perform the fast-forward/rewind as the preferential data blocks to store them in the buffer memory 34 as shown in FIG. 7, respectively.

After confirming the completion of reading the preferential data blocks in a step 4c, the CPU 31 next shifts to a step 4d to read non-preferential data blocks other than the preferential data blocks in series. In a step 4e, the CPU 31 determines whether or not the buffer memory 34 is in an overflow state, and if not in the overflow state, it stores the non-preferential data blocks in series in free areas in a step 4f. For example, as shown in FIG. 7, the CPU 31 stores each block B5, B6, B7, etc., of the music data in succession to the aforementioned preferential data block group.

On the contrary, it is presumed that the buffer memory 34 has overflowed during storage processing of the data blocks. In this case, the CPU 31 shifts to a step 4g to overwrite-store data blocks Bi, Bi+1, etc., read from the HDD unit 24 after that onto non-preferential data blocks B5, B6, etc., except a preferential data block group FB among each data block already been stored in the buffer memory 34 as shown in FIG. 8. Therefore, even after the overflow of the buffer memory 34, the preferential data blocks are still held on the buffer memory 34.

After a competition of read of all data blocks consisting of the content data to be reproduced, the CPU 31 detects the fact in a step 4h to terminate buffering processing of the content data.

When all of or a part of a plurality of data blocks constituting the content data is stored in the buffer memory 34, the CPU 31 starts data reproduction processing as follows in a step 3i. The CPU 31 refers the access information B1 in a step 5a firstly and reads in series the data blocks B4, B5, etc., to be reproduced from the buffer memory 34 through a step 5b. The CPU 31 then sequentially supplies the read data blocks B4, B5, B6, etc., to the audio decoder in the compander 17 in a step 5c. Thereby, the data blocks B4, B5, B6, etc., are sequentially decoded by the audio decoder, further converted into analog audio signals through the PCM codec 18, and then, amplified by the reception amplifier 19 to be output from the loud speaker 20.

It is assumed that the user performs a changing operation for a reproduction mode during a reproduction of the content data. The CPU 31 then makes a shift from the step 5d to a step 5e to determine changing content of the reproduction mode. Reproduction processing by the changed reproduction mode is conducted through the steps 5f to 5h on the basis of the determination result.

For instance, it is supposed that the user performs a fast-forward or rewind operation, the CPU 31 reads out the management information Bend for fast-forward/rewind stored in the buffer memory 34, and reads the data blocks to be reproduced in a forward direction or in a reverse direction sequentially from the buffer memory 34 on the basis of the management information Bend to supply them to the audio decoder in the compander 17. Thus, the fast-forward or rewind reproduction of the music content data is carried out.

It is presumed that the user conducts an operation to display the jacket picture data B2 or the song lyric data B3 during the reproduction of the music content data. The CPU 31 then reads the jacket picture data B2 or the song lyric data B3 stored in the buffer memory 34 and decodes the read data to display it on the main display 28.

The preferential buffering processing and data reproduction processing of the content data through the steps 3h to 3i are repeatedly executed until the reproduction completion will be detected in a step 3j.

As mentioned above, in the embodiment, the portable electronic device divides the content data stored in the HDD unit 24 into the data block group with the high priority such as management data related to the user's operation and other data block group with the low priority such as music data. When reading the content data from the HDD unit 24 to store it in the buffer memory 34, the electronic device firstly and selectively reads the preferential data block group from the HDD unit 24 to store it in the buffer memory 34 and reads the non-preferential data block group other than the preferential data block group after reading it to store the non-preferential data block group in the buffer memory 34.

Accordingly, the data blocks of the high priorities are read preferentially to be stored in the buffer memory 34. Therefore, even if the preferential data blocks are arranged in any positions in the content data, the electronic device can store the preferential data blocks in the buffer memory 34 quickly. Thereby, it becomes possible for the electronic device to start the reproduction control for the content data instantaneously.

In a state that any free area is present in the buffer memory 34, the electronic device stores in series the data blocks read from the HDD unit 24 in the free areas in the buffer memory 34. In contrast, when every free area in the buffer memory 34 runs out, the electronic device overwrites and stores the data blocks read from the HDD unit 24 onto the non-preferential data blocks among each data block already stored in the buffer memory 34.

Consequently, even when the buffer memory 34 has overflowed, and the risk that the high-priority data block group is overwritten by the lower-priority data block group is eliminated, thereby, the electronic device can keep the high-priority data block from leaving on the buffer memory 34. As a result, when the user conducts the operation changing the reproduction mode in the midst of the reproduction, the electronic device can quickly start the reproduction processing operation for this operation after the change of the reproduction mode.

Further, the electronic device is provided with the priority information table 341 to store the information showing a relationship between the type of the content data and the information showing the arrangement positions of the data elements with the high priorities among the content data in the information table 341. Based on the information stored in the information table 341, the electronic device specifies whether or not the content data is one to be buffer-managed and the preferential data block corresponding to the types of the content data. Thereby, the electronic device can perform the buffering processing according to the priorities only to the content data of the types needed to be buffering-managed, and to perform the buffering processing in accordance with an optimum priority corresponding to the data structure for each type of content data.

The present invention is not limited to the aforementioned embodiment. For instance, having described the case in which the HDD unit 24 housed in the cellular phone is used as a storage unit as an example; however, the invention is not limited to such case, the present invention can be adopted to the case in which a memory card (external storage unit) such as a flash memory is utilized as the storage unit. In this case, the cellular phone is provided with a slot to attachably/detachably mount the external storage unit thereto and reads the data blocks from the external storage unit through the slot to store it in the buffer memory 34.

The embodiment is so constituted as; to divide the content data into a plurality of blocks with fixed lengths, to read the content data in block units from the HDD unit 24 and store it in the buffer memory 34. However, the present invention is not limited to this way, it may be constituted to divide the content data in each data element unit into a plurality of blocks with variable lengths, to read the content data in block units from the HDD unit 24 and store it in the buffer memory 34.

Further, in the embodiment, the cellular phone having been described as an example, the present invention is applicable, in a similar manner other than the cellular phone, to a PDA, a small-sized notebook personal computer, a portable game machine, an audio/video player, a digital camera, etc., other than the cellular phone.

In addition, the present invention can be embodied, by modifying in a variety types of embodiments without departing from the concept of the invention, for the types and data structures of the content data, the types and number of the data elements to be given the first priorities, the order of the read of the content data and the storage positions thereof on the buffer memory, the procedure and contents of the preferential buffering processing, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic device, comprising:
a storage unit configured to store content data including a first data block group given a first priority in relation to a user's operation and a second data block group given a second priority set lower than the first priority;
a buffer memory configured to temporarily store content data read from the storage unit;
a reproduction unit configured to reproduce the content data read from the buffer memory; and
a control unit configured to connect to the storage unit, the buffer memory and the reproduction unit, wherein
the control unit comprises:
a first controller configured to read the content data in block units from the storage unit to store the read data blocks in the buffer memory in accordance with their priorities; and
a second controller configured to selectively read the data blocks stored in the buffer memory to make the reproduction unit reproduce the read data blocks.

2. The portable electronic device according to claim 1, wherein
the first controller comprises:
means for determining whether or not any free area is present in the buffer memory;
means for storing the data blocks read from the storage unit in a free area of the buffer memory in a state in which no free area is present in the buffer memory; and
means for storing the data blocks read from the storage unit as a substitute for the second data block group among first and second data block groups already stored in the buffer memory.

3. The portable electronic device according to claim 1, wherein
the first controller comprises:
means for reading the first data block group in block units from the storage unit to store it in the buffer memory; and
means for reading the second data block group in block units from the storage unit to store it in the buffer memory after completion of reading the first data block group.

4. The portable electronic device according to claim 1, wherein
the first controller comprises:
a memory table configured to store information showing an arrangement position of the first data block group in the content data by associating it with a type of the content data;
means for determining a type of content data to be reproduced when a reproduction request for the content data is input;
means for reading information showing the arrangement position of the first data block group corresponding to the determined type; and
means for selectively reading the first data block group from the storage unit to store it in the buffer memory on the basis of the read information showing the arrangement position.

5. A portable electronic device, comprising:
a memory slot configured to load an external storage unit with content data including a first data block group given a first priority and a second data block group given a second priority set lower than the first priority stored therein;
a buffer memory configured to temporarily store content data read from the buffer memory; and
a reproduction unit configured to reproduce the content data read from the buffer memory; and
a control unit configured to connect to the memory slot, the buffer memory and the reproduction unit, wherein
the control unit comprises:
a first controller configured to read the content data in block units through the memory slot from the storage unit to store the read data blocks in the buffer memory in accordance with their priorities; and
a second controller configured to selectively read the data blocks stored in the buffer memory to make the reproduction unit reproduce the read data blocks.

6. The portable electronic device according to claim 5, wherein
the first controller comprises:
means for determining whether or not any free area is present in the buffer memory;
means for storing the data blocks read from the storage unit in free areas of the buffer memory in a state in which any free area is present in the buffer memory; and
means for storing the data blocks read from the storage unit as a substitute for a second data block group among first and second data block groups already stored in the buffer memory.

7. The portable electronic device according to claim 5, wherein
the first controller comprises:
means for reading the first data block group in block units from the storage unit to store it in the buffer memory; and
means for reading the second data block group in block units from the storage unit to store it in the buffer memory after completion of reading the first data block group.

8. The portable electronic device according to claim 5, wherein
the first controller comprises:
a memory table to store information showing an arrangement position of the first data block group in the content data by associating it with a type of the content data;
means for determining a type of content data to be reproduced when a reproduction request for the content data is input;
means for reading information showing the arrangement position of the first data block corresponding to the determined type; and
means for selectively reading the first data block from the storage unit to store it in the buffer memory on the basis of the read information showing the arrangement position.
